(19) United States
(12) Patent Application Publication
(10) Pub. No.: US 2017/0193393 A1
(43) Pub. Date: Jul. 6, 2017

(54) Automated Knowledge Graph Creation

(71) Applicant: International Business Machines Corporation, Armonk, NY (US)

(72) Inventors: Danish Contractor, Bangalore (IN); Mukesh K. Mohania, Bangalore (IN); Nitendra Rajput, Bangalore (IN); Renuka R. Sindhgatta, Bangalore (IN)

(21) Appl. No.: 14/987,067

(22) Filed: Jan. 4, 2016

(51) Int. Cl. G06N 99/00; G06N 5/02

(52) U.S. Cl. CPC G06N 99/005; G06N 5/022

(57) ABSTRACT

Methods, systems, and computer program products for automated knowledge graph creation are provided herein. A computer-implemented method includes generating an initial knowledge graph based on analysis of a learning curriculum, wherein each node in the graph represents a concept to be learned by a user, and each edge in the graph represents a pre-requisite relationship between two or more of the concepts; labelling multiple documents related to the learning curriculum by annotating learning instructions and learning concepts within the documents; augmenting the graph with one or more additional edges based on the labelled documents, thereby creating an augmented knowledge graph with (i) augmented pre-requisite relationships between the concepts represented in the initial knowledge graph and (ii) one or more additional pre-requisite relationships between two or more of the concepts not represented in the initial knowledge graph; and outputting the augmented knowledge graph for implementation in a learning context.

### FIELD

The present application generally relates to information technology, and, more particularly, to knowledge graph creation.

### BACKGROUND

Learning standards include a taxonomy of learning instructions commonly organized by grade, subject, course, topic, etc. Different learning standards can include different organizational structures. A knowledge graph can attempt to model relationships between concepts. However, existing approaches fail to incorporate learning progression into learning knowledge (concept) graphs. Additionally, existing approaches face challenges upon encountering different learning curricula across different schools and/or geographic regions. Further, many existing approaches include manual creation of knowledge graphs, which can be time consuming, error-prone and expensive.

### SUMMARY

In one embodiment of the present invention, techniques for automated knowledge graph creation are provided. An exemplary computer-implemented method can include steps of generating an initial knowledge graph based on analysis of at least one input learning curriculum, wherein each node in the initial knowledge graph represents a concept to be learned by a user, and wherein each edge in the initial knowledge graph represents a pre-requisite relationship between two or more of the concepts. The method also includes labelling multiple documents related to the at least one input learning curriculum, wherein said labelling comprises annotating one or more learning instructions and one or more learning concepts within the multiple documents. Further, the method also includes augmenting the initial knowledge graph with one or more additional edges based on the labelled documents, thereby creating an augmented knowledge graph with (i) augmented pre-requisite relationships between the two or more concepts represented in the initial knowledge graph and (ii) one or more additional pre-requisite relationships between two or more of the concepts not represented in the initial knowledge graph. Additionally, the method includes outputting the augmented knowledge graph to at least one of (i) a display, (ii) a user interface, and (iii) a user for implementation in a learning context.

In another embodiment of the invention, an exemplary computer-implemented method can include capturing multiple learning instructions that are (i) derived from the at least one input learning curriculum and (ii) pertaining to the concepts in the initial knowledge graph, and extracting one or more keywords from each of the multiple learning instructions. Such a method can also include leveraging multiple knowledge sources to generate one or more expansions of each of the one or more extracted keywords, and adding one or more additional edges representing one or more additional pre-requisite relationships between two or more of the concepts to the initial knowledge graph based on the one or more expansions of each of the one or more keywords extracted from the multiple learning instructions to create an augmented knowledge graph.

Another embodiment of the invention or elements thereof can be implemented in the form of an article of manufacture tangibly embodying computer readable instructions which, when implemented, cause a computer to carry out a plurality of method steps, as described herein. Furthermore, another embodiment of the invention or elements thereof can be implemented in the form of an apparatus including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a learning standard tree, according to an exemplary embodiment of the invention;

FIG. 2 is a diagram illustrating system architecture, according to an exemplary embodiment of the invention;

FIG. 3 is a flow diagram illustrating techniques according to an embodiment of the invention; and

FIG. 4 is a system diagram of an exemplary computer system on which at least one embodiment of the invention can be implemented.

### DETAILED DESCRIPTION

As described herein, an embodiment of the present invention includes techniques for automated knowledge graph creation. As noted above, a learning concept and/or knowledge graph can define the relationships between concepts from a learning point of view, wherein each node is a concept (or a sub-concept) and each edge denotes a pre-requisite relationship between concepts (or sub-concepts). Accordingly, by following the edges, a set of all pre-requisites for a concept can be determined.

At least one embodiment of the invention includes automatically creating a knowledge graph by building concept pre-requisite relationships. Such an embodiment can include utilizing a learning curriculum standard and labeled content tagged via the curriculum standard to establish a base graph and to identify concept sequences (or pre-requisites) for building knowledge graph relationships. As used herein, a learning standard refers to a hierarchy of concepts and/or teaching instructions that describe what skills a learner should acquire during his or her education progression. Additionally, the knowledge graph relationships can be extended and/or modified based on usage characteristics.

As noted above, given a collection of documents (educational content) and a learning standard, at least one embodiment of the invention includes labelling the documents within the collection with instructions from the learning standard. Specifically, each learning material is being labeled with the learning standard instructions and/or concepts related thereto. Using the curriculum learning standard along with content labeled with curriculum learning standard instructions, at least one embodiment of the invention can include further learning graph usage data to automatically construct a learning knowledge graph. The knowledge graph can be generated and/or implemented for a specific subject and/or can be implemented cross-curricula, and the concepts or items of the knowledge graph can be defined based on the learning standards. In such an instance, different types of concepts and dependencies can be built using learning content. As used herein, learning content refers to any material that is used and/or referred to by users (students, for example) for educational purposes.

In at least one embodiment of the invention, a learning standard curriculum is translated to a base graph with minimal edges as defined in the curriculum. Such edges can represent, for example, grade-to-grade pre-requisites. Additionally, concepts that are taught across multiple grades can be automatically labeled at this stage. Also, learning objects such as, for example, lecture notes, lecture transcripts, tutorials, textbooks (and/or portions from textbooks (such as chapters, sections, etc.)) can be labeled automatically with the curriculum learning standard.

Further, in one or more embodiments of the invention, the base graph can be augmented with additional edges using the labeled content. The labeled content can contain pre-requisites which can be mapped and identified in the graph. Accordingly, the node to which the labeled content maps can thus be made aware of its pre-requisites.

In one or more embodiments of the invention, each learning standard instruction can be represented as a node. Accordingly, in such an embodiment, the words “node,” “instruction,” and “learning standard instruction,” for example, can be used interchangeably. Due to the hierarchical organization of instructions into grades, subjects, and courses, as well as due to the fact that grades often enforce linear pre-requisite relationships on a sub-tree, a base graph with pre-requisites can be constructed via one or more embodiments of the invention. To determine sequences within grades, one or more embodiments of the invention include leveraging the learning material. Additionally, documents can be (automatically) labelled with learning standard instructions. Once the documents have been labelled, at least one embodiment of the invention can include identifying which portions of the text in the learning document correspond to which learning standard instruction (node). As such, if, for example, a book is being utilized, and the portions of the book are labelled with learning standard instructions, an example embodiment of the invention can include mapping a learning standard to a point in the book and determining an ordering within these nodes because of the ordering of the concepts in the presentation of the book. The ordering can be determined, for example, by aggregating the mapping information in connection with multiple learning documents.

Learning content (such as textbooks) can provide a study sequence, and/or, for example, chapter sequences of a source such as a textbook can be used to determine a study sequence. As such, depending on the node to which the content chunks map in the base graph, one or more pre-requisite relationships can be further established. By way of example, if a first content chunk (content_chunk_1) maps to node-19, and content_chunk_2 maps to node-3, and if the learning object from which the chunks content_chunk_1 and content_chunk_2 were sourced occur in the sequence content_chunk_1→content_chunk_2, then node-19 can be labeled as a pre-requisite to node-3.

Also, edges can be drawn, for example, based on aggregated votes from multiple items of learning content. In addition, the content chunks may themselves have specified the node which serves as a pre-requisite. Once all such links are created, at least one embodiment of the invention includes removing obvious 1-hop transitive pre-requisites to reduce graph density. In other words, if Node 1 is a pre-requisite for Node 2, if Node 2 is a pre-requisite for Node 3, having an edge connecting Node 1 to Node 3 would be redundant because of transitivity. Further, in one or more embodiments of the invention, the output of such embodiments (namely, the knowledge graph) can be provided to one or more experts to verify and update with additions, deletions, etc. Consequently, at least one embodiment of the invention can include serving as a starting graph to any knowledge graph authoring tool used by experts.

In one or more embodiments of the invention, no assumptions are made about the knowledge graph nodes. Accordingly, the nodes can contain, for example, minimal metadata such as text and instruction identifier, or the nodes can contain complex data structures storing metadata about the available learning content, the complexity of the concept(s), etc.

As noted herein, a knowledge graph can also be updated using usage statistics and/or usage characteristics. For example, if the graph is used in a learning system wherein learners navigate the graph and acquire skills by studying content in sequences governed by the concepts encoded in the graph, at least one embodiment of the invention can include using aggregated and/or representative measures of how students perform to modify edges. For example, if more than x % of students navigate from studying node 2 to node 7 during the course of a year, a direct edge can be added between node 2 and node 7.

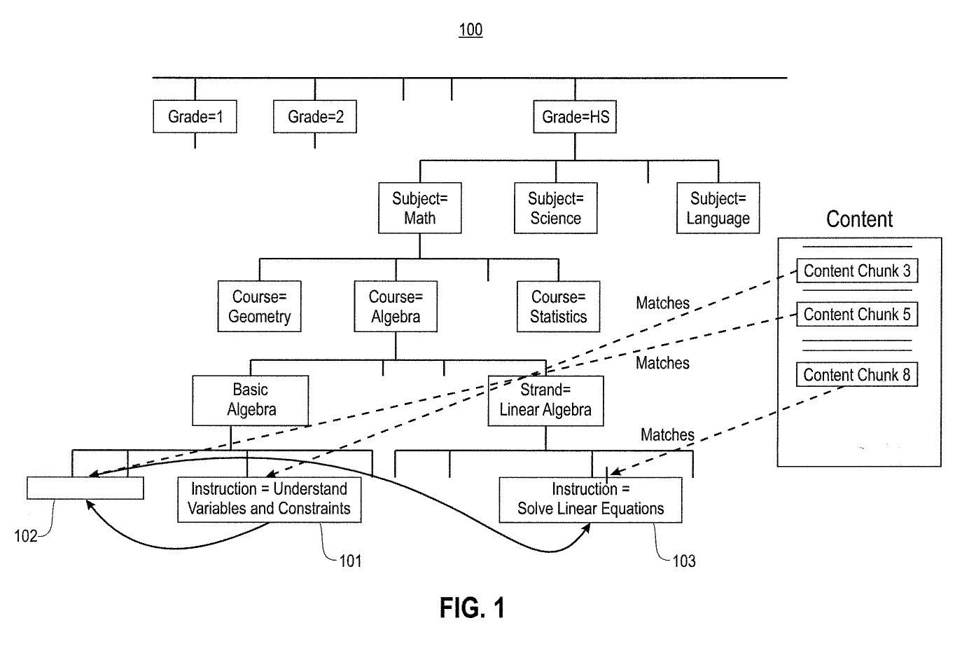

FIG. 1 is a diagram illustrating a learning standard tree 100, according to an embodiment of the invention. By way of illustration, in FIG. 1, the dashed lines represent the highlighted content chunks matching particular nodes in the learning graph 100. As used herein, “matching” refers to the labeling of portions of text in a learning document with a learning standard instruction. Specifically, content chunk 3 matches node 101, content chuck 5 matches node 102, and content chunk 8 matches node 103. Additionally, as depicted in FIG. 1, the solid arcs (such as the arc from node 101 to node 102, as well as the arc from node 102 to node 103) show creation of the knowledge graph with the highlighted learning content. Additionally, one or more embodiments of the invention can include creating the graph in a particular sequence. For example, in the example depicted in FIG. 1, the creation sequence can proceed from node 101 to node 102, and subsequently to node 103.

Further, as noted herein, at least one embodiment of the invention can include implementing one or more updates to a created graph. By way of illustration, consider the following example scenarios. If a majority of students perform well (as measured by a given indicator of performance) on a skill pre-requisite, an additional edge to more challenging concepts can be introduced from the relevant concept(s) in the graph (that is, the concepts in which the majority of students are performing well). If, however, a majority of students do not perform well in a pre-requisite concept and require remediation and/or study of other concepts (which may include a direct link in the graph), links (edges) can be created to the intended concept(s) of study. This can be useful, for example, in knowledge graphs which encode a decay factor in an assessment score of a pre-requisite. As used herein, a decay factor refers to any term that reduces the score earned by a user/student on an assessment of a pre-requisite. For example, score=score−score*0.05*(the number of years since the student took the exam) would reduce the score by the noted decay factor. Additionally, as used herein, an assessment score of a pre-requisite refers to the performance of a student in an exam that evaluated the concepts of the given pre-requisite. Further, if a majority students perform well after following a first learning path over a second learning path, at least one embodiment of the invention can include creating pre-requisites using concepts from the first learning path.

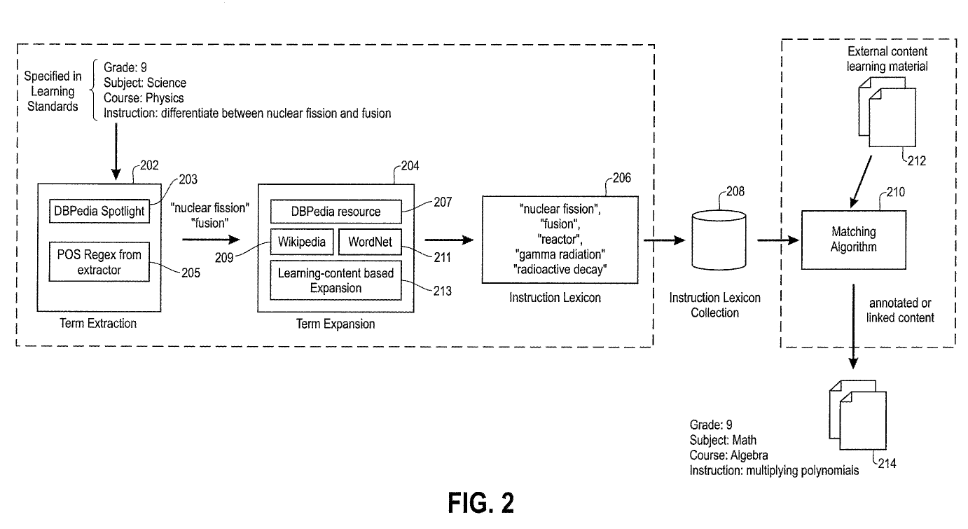

FIG. 2 is a diagram illustrating system architecture, according to an exemplary embodiment of the invention. By way of illustration, FIG. 2 depicts a term extraction component 202, which provides input to a term expansion component 204, which provides input to an instruction lexicon component 206. As further described herein, the term extraction component 202 includes a DBPedia spotlight sub-component 203, and a part-of-speech (POS) regular expression (regex) sub-component 205. Additionally, the term expansion component 204 includes a DBPedia resource sub-component 207, a Wikipedia® sub-component 209, a WordNet® sub-component 211, and a learning-content based expansion sub-component 213. It should be noted that while the example embodiment depicted in FIG. 2 includes a DBPedia spotlight sub-component, one or more additional embodiments of the invention can include utilizing any system and/or method component that enables identification of concepts and associated DBPedia/Wikipedia® pages.

As also depicted in FIG. 2, the instruction lexicon component 206 provides input to an instruction lexicon collection and/or database 208, which provides input to a matching algorithm component 210. The matching algorithm component 210, based on the input received from the instruction lexicon database 208 as well as input received from external content and/or learning material 212, generates an output 214 of annotated and/or linked content in connection with an instruction.

Referring again to the term extractor component 202 noted above, such a component receives input via learning standards, wherein such input can include an identified grade level, an identified subject, an identified course of study, and an instruction related to a task or concept relevant to the identified course of study. In the example illustrated in FIG. 2, the input identifies grade 9, the subject of science, the course of study of physics, and an instruction to differentiate between nuclear fission and fusion.

The term extractor component 202 carriers out the extraction of key terms from the provided input. Such extraction can include, for example, word frequency based keyword extraction (that is, a word that is used in the input with a frequency greater than a predetermined threshold can be extracted). Extraction can also include POS tagging carried out via POS regex sub-component 205, which facilitates noun-phrase extraction. For example, POS tagging can be carried out using a natural language processing toolkit for POS tagging and chunking. Additionally, as noted above, the term extractor component 202 includes a DBPedia spotlight component 203, which includes a web tool for annotating mentions of DBPedia resources in input text, and can also provide uniform resource locators (URLs) to corresponding DBPedia resources. Also, it should be noted that there is generally one DBPedia entry for each Wikipedia® article, wherein the DBPedia entry contains details about page categories, etc.

Ultimately, the term extractor component 202 outputs instruction keywords and/or phrases to the term expansion component 204, which leverages multiple knowledge sources, such as DBPedia resource sub-component 207, Wikipedia® sub-component 209, WordNet®, sub-component 211, and learning-content (such as school text) based expansion sub-component 213, to identify relevant document snippets and/or relevant words from the knowledge sources to generate an expanded lexicon 206 related to the instruction keywords and/or phrases. As further detailed herein, the instruction keywords and/or phrases are supplemented with the expanded lexicon 206 and provided to the instruction lexicon database 208 as well as to the matching algorithm component 210.

Referring back to the term expansion component 204, sub-component 209 can use an extracted term and/or phrase from the instruction to match against Wikipedia® title pages. Sub-component 209 can also extract categories of wild page, which includes navigating a parent chain of each category to discard noisy categories. For example, “exponents” can be extracted via pages from the categories of mathematics, business, law, etc. Keywords can then be extracted from the obtained pages, and a text rank algorithm can be applied, thereby generating an output that can be used as an expanded set. By way of example, one or more embodiments of the invention can include expanding terms using the introductory passages of a related Wikipedia® page.

Additionally, the learning-content based expansion sub-component 213 can search for and/or download external data, such as textbooks, articles, etc., and build an index of the external data. By way of example, one or more embodiments of the invention can include retrieving documents using an inverted term frequency-inverse document frequency (tf-idf) based index using the term as a search query and searching for concepts in those documents. Such concept detection can make use of any system and/or method that enables identification of concepts and associated DBPedia/Wikipedia® pages.

Referring back to the matching algorithm component 210, at least one embodiment of the invention can include querying for terms extracted from the instruction. Such an embodiment can include extracting keywords and/or phrases (via a text rank algorithm) from the top k ranked matching documents.

Additionally, the matching algorithm component 210 can carry out instruction-document matching. Such matching can include determining a match against all nodes in a given tree and link at all levels (instruction, strand, course, subject, grade, etc.). Matches can be determined, for example, using a scoring function that takes a tf-idf such as a vectorized representation of the instructions and documents. A valid path is identified if a parent node score≧a fraction of child score. As used herein, a parent refers to any node defined as the parent in a learning standard. The parent of an instruction can include a particular strand and/or topic, for example. Additionally, all instructions can be merged to create a “topic” document and its tf-idf vector representation when compared (using cosine similarity, for example) with a vector representation of the document to generate the “parent” score for the instruction. Further, at least one embodiment of the invention can include sorting based on (i) leaf node score, and/or (ii) the average of all node scores in a given path.

Additionally, one or more embodiments of the invention can include pruning the lexicon based on a computation of a relevance score of each expansion. Such a relevance score can be computed as follows:

$$RelScore ( {t}_{exp} , T ) = \frac{{\sum }_{∀ t ∈ T} {w}_{t , {t}_{exp}}}{\vert T \vert} ,$$

wherein w_{t,t}_{ₑₓₚ} is a similarity score between an expansion tₑₓₚεTₑₓₚ and term tεT. As such, the relevance score of each expansion is the average similarity value with all terms in the instruction. Also, in at least one embodiment of the invention, the similarity score is based on a normalized Wikipedia® distance as follows:

$$N W D ( {t}_{1} , {t}_{2} ) = \frac{max ( log ( {N}_{t 1} ) , log ( {N}_{t 2} ) ) - log ( {N}_{t 1 , t 2} )}{log N - min ( log ( {N}_{t 1} ) , log ( {N}_{t 2} ) )} ,$$

where Nₜ₁ is the number of articles returned from the Wikipedia® dataset when term t₁ is used as the keyword for querying, Nₜ₂ is the number of articles returned from the Wikipedia® dataset when term t₂ is used as the keyword for querying, N_{t1,t2} is the number of documents when both terms t₁ and t₂ are used to query the Wikipedia® dataset, and N is the total number of Wikipedia® articles indexed.

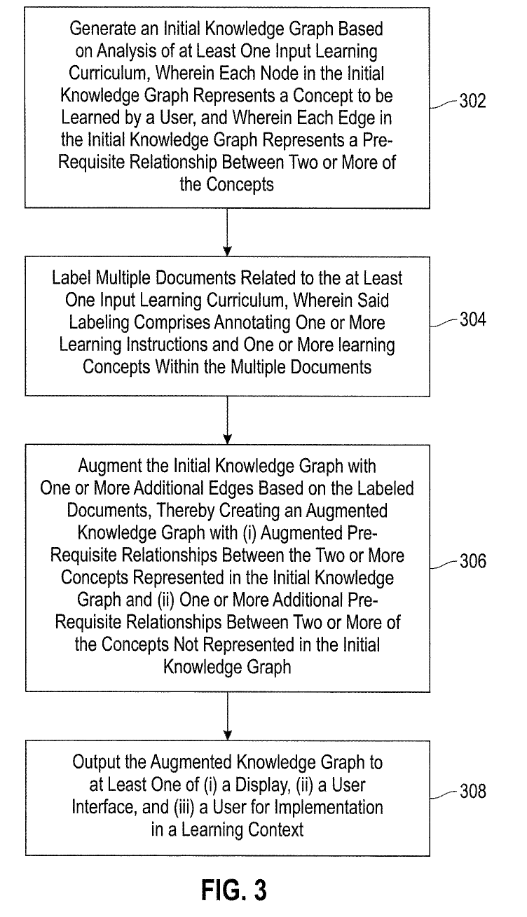

FIG. 3 is a flow diagram illustrating techniques according to an embodiment of the present invention. Step 302 includes generating an initial knowledge graph based on analysis of at least one input learning curriculum, wherein each node in the initial knowledge graph represents a concept to be learned by a user, and wherein each edge in the initial knowledge graph represents a pre-requisite relationship between two or more of the concepts. Each edge in the initial knowledge graph can represent a grade-level-to-grade-level pre-requisite. Also, the initial knowledge graph can encompass a specific subject and/or can be implemented across multiple learning curricula.

Step 304 includes labelling multiple documents related to the at least one input learning curriculum, wherein said labelling comprises annotating one or more learning instructions and one or more learning concepts within the multiple documents. Each of the one or more learning instructions can include one or more keywords and/or key phrases, an identified grade level, an identified subject, an identified course of study, and/or an instruction related to one or more of the concepts in the initial knowledge graph. At least one embodiment of the invention can also include pruning the labelled documents based on a computation of a relevance score for each of the labelled documents.

Step 306 includes augmenting the initial knowledge graph with one or more additional edges based on the labelled documents, thereby creating an augmented knowledge graph with (i) augmented pre-requisite relationships between the two or more concepts represented in the initial knowledge graph and (ii) one or more additional pre-requisite relationships between two or more of the concepts not represented in the initial knowledge graph. Augmenting can include deriving one or more additional pre-requisites between two or more of the concepts from the labelled documents. Additionally, one or more embodiments of the invention can include mapping the one or more additional pre-requisites to the two or more concepts in the initial knowledge graph.

Step 308 includes outputting the augmented knowledge graph to at least one of (i) a display, (ii) a user interface, and (iii) a user for implementation in a learning context. The techniques depicted in FIG. 3 can also include modifying the augmented knowledge graph based on one or more usage characteristics of the knowledge graph.

Also, an additional embodiment of the invention includes capturing multiple learning instructions that are (i) derived from the at least one input learning curriculum and (ii) pertaining to the concepts in the initial knowledge graph, and extracting one or more keywords from each of the multiple learning instructions. Such an embodiment can also include leveraging multiple knowledge sources to generate one or more expansions of each of the one or more extracted keywords, and adding one or more additional edges representing one or more additional pre-requisite relationships between two or more of the concepts to the initial knowledge graph based on the one or more expansions of each of the one or more keywords extracted from the multiple learning instructions to create an augmented knowledge graph.

At least one embodiment of the invention (such as the techniques depicted in FIG. 3, for example), can include implementing a service via a transmission server to receive data from a data source and send selected data to users (for example, at a provided destination address of a wireless device (such as a number for a cellular phone, etc.)). The transmission server includes a memory, a transmitter, and a microprocessor. Such an embodiment of the invention can also include providing a viewer application to the users for installation on their individual devices. Additionally, in such an embodiment of the invention, after a user enrolls, the service receives learning standards information sent from a data source to the transmission server. The server can process the information, for example, based upon user-provided user preference information that is stored in memory on the server. Subsequently, an alert is generated containing an augmented knowledge graph. The alert can be formatted into data blocks, for example, based upon any provided alert format preference information. Subsequently, the alert and/or formatted data blocks are transmitted over a data channel to the user's wireless device. After receiving the alert, the user can connect the wireless device to the user's computer, whereby the alert causes the user's computer to automatically launch the application provided by the service to display the alert. When connected to the Internet, the user may then use the viewer application (for example, via clicking on a URL associated with the data source provided in the alert) to facilitate a connection from the remote user computer to the data source over the Internet for additional information.

The techniques depicted in FIG. 3 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 3 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

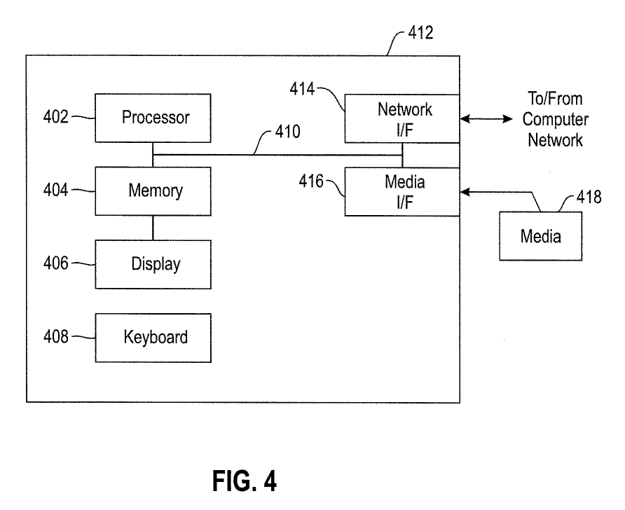

Additionally, an embodiment of the present invention can make use of software running on a computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 402. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, automatically using content sequencing information to build knowledge graph relationships.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating an initial knowledge graph based on analysis of at least one input learning curriculum, wherein each node in the initial knowledge graph represents a concept to be learned by a user, and wherein each edge in the initial knowledge graph represents a pre-requisite relationship between two or more of the concepts;
labelling multiple documents related to the at least one input learning curriculum, wherein said labelling comprises annotating one or more learning instructions and one or more learning concepts within the multiple documents;
augmenting the initial knowledge graph with one or more additional edges based on the labelled documents, thereby creating an augmented knowledge graph with (i) augmented pre-requisite relationships between the two or more concepts represented in the initial knowledge graph and (ii) one or more additional pre-requisite relationships between two or more of the concepts not represented in the initial knowledge graph; and
outputting the augmented knowledge graph to at least one of (i) a display, (ii) a user interface, and (iii) a user for implementation in a learning context;
wherein the steps are carried out by at least one computing device.

2. The computer-implemented method of claim 1, wherein each edge in the initial knowledge graph represents a grade-level-to-grade-level pre-requisite.

3. The computer-implemented method of claim 1, wherein each of the one or more learning instructions comprises one or more keywords and/or key phrases.

4. The computer-implemented method of claim 1, wherein each of the one or more learning instructions comprises an identified grade level.

5. The computer-implemented method of claim 1, wherein each of the one or more learning instructions comprises an identified subject.

6. The computer-implemented method of claim 1, wherein each of the one or more learning instructions comprises an identified course of study.

7. The computer-implemented method of claim 1, wherein each of the one or more learning instructions comprises an instruction related to one or more of the concepts in the initial knowledge graph.

8. The computer-implemented method of claim 1, comprising:
pruning the labelled documents based on a computation of a relevance score for each of the labelled documents.

9. The computer-implemented method of claim 1, wherein said augmenting comprises deriving one or more additional pre-requisites between two or more of the concepts from the labelled documents.

10. The computer-implemented method of claim 9, comprising:
mapping the one or more additional pre-requisites to the two or more concepts in the initial knowledge graph.

11. The computer-implemented method of claim 1, comprising:
modifying the augmented knowledge graph based on one or more usage characteristics of the knowledge graph.

12. The computer-implemented method of claim 1, wherein the initial knowledge graph encompasses a specific subject.

13. The computer-implemented method of claim 1, wherein the initial knowledge is implemented across multiple learning curricula.

14. A computer program product comprising a computer readable storage medium having program instructions embodied therewith, the program instructions executable by a device to cause the device to:
generate an initial knowledge graph based on analysis of at least one input learning curriculum, wherein each node in the initial knowledge graph represents a concept to be learned by a user, and wherein each edge in the initial knowledge graph represents a pre-requisite relationship between two or more of the concepts;
label multiple documents related to the at least one input learning curriculum, wherein said labelling comprises annotating one or more learning instructions and one or more learning concepts within the multiple documents;
augment the initial knowledge graph with one or more additional edges based on the labelled documents, thereby creating an augmented knowledge graph with (i) augmented pre-requisite relationships between the two or more concepts represented in the initial knowledge graph and (ii) one or more additional pre-requisite relationships between two or more of the concepts not represented in the initial knowledge graph; and
output the augmented knowledge graph to at least one of (i) a display, (ii) a user interface, and (iii) a user for implementation in a learning context.

15. The computer program product of claim 14, wherein the program instructions executable by a computing device further cause the computing device to:
prune the labelled documents based on a computation of a relevance score for each of the labelled documents.

16. The computer program product of claim 14, wherein said augmenting comprises deriving one or more additional pre-requisites between two or more of the concepts from the labelled documents.

17. The computer program product of claim 16, wherein the program instructions executable by a computing device further cause the computing device to:
map the one or more additional pre-requisites to the two or more concepts in the initial knowledge graph.

18. The computer program product of claim 14, wherein the program instructions executable by a computing device further cause the computing device to:
modify the augmented knowledge graph based on one or more usage characteristics of the knowledge graph.

19. A system comprising:
a memory; and
at least one processor coupled to the memory and configured for:
generating an initial knowledge graph based on analysis of at least one input learning curriculum, wherein each node in the initial knowledge graph represents a concept to be learned by a user, and wherein each edge in the initial knowledge graph represents a pre-requisite relationship between two or more of the concepts;
labelling multiple documents related to the at least one input learning curriculum, wherein said labelling comprises annotating one or more learning instructions and one or more learning concepts within the multiple documents;
augmenting the initial knowledge graph with one or more additional edges based on the labelled documents, thereby creating an augmented knowledge graph with (i) augmented pre-requisite relationships between the two or more concepts represented in the initial knowledge graph and (ii) one or more additional pre-requisite relationships between two or more of the concepts not represented in the initial knowledge graph; and
outputting the augmented knowledge graph to at least one of (i) a display, (ii) a user interface, and (iii) a user for implementation in a learning context.

20. A computer-implemented method, comprising:
generating an initial knowledge graph based on analysis of at least one input learning curriculum, wherein each node in the initial knowledge graph represents a concept to be learned by a user, and wherein each edge in the initial knowledge graph represents a pre-requisite relationship between two or more of the concepts;
capturing multiple learning instructions that are (i) derived from the at least one input learning curriculum and (ii) pertaining to the concepts in the initial knowledge graph;
extracting one or more keywords from each of the multiple learning instructions;
leveraging multiple knowledge sources to generate one or more expansions of each of the one or more extracted keywords;
adding one or more additional edges representing one or more additional pre-requisite relationships between two or more of the concepts to the initial knowledge graph based on the one or more expansions of each of the one or more keywords extracted from the multiple learning instructions to create an augmented knowledge graph; and
outputting the augmented knowledge graph to at least one of (i) a display, (ii) a user interface, and (iii) a user for implementation in a learning context;
wherein the steps are carried out by at least one computing device.
